(19) United States
(12) Patent Application Publication
(10) Pub. No.: US 2016/0197566 A1
(43) Pub. Date: Jul. 7, 2016

(54) METHOD AND APPARATUS TO CONTROL A SINGLE-PHASE INDUCTION MOTOR

(71) Applicant: Tecumseh Products Company, Inc., Ann Arbor, MI (US)

(72) Inventors: Alex ALVEY, Saline, MI (US); Claudia Andrea DA SILVA, Ann Arbor, MI (US); Cassio MAULE, Ann Arbor, MI (US); Marcelo REAL, Saline, MI (US)

(21) Appl. No.: 14/912,148

(22) PCT Filed: Aug. 16, 2014
(86) PCT No.: PCT/US2014/051389

§ 371 Date: Feb. 15, 2016

Related U.S. Application Data
(60) Provisional application No. 61/866,766, filed on Aug. 16, 2013.

(51) Int. Cl. H02P 1/42; H02P 25/04

(52) U.S. Cl. CPC H02P 1/423; H02P 25/04

(57) ABSTRACT

A motor drive for and a method of controlling a motor. In one example, the motor drive controls the motor to simulate capacitors and achieve optimal performance of a mechanical machine. In another example, the motor drive controls the motor to operate at a constant speed corresponding to a selected soft-capacity value selected before operating the motor.

### CROSS-REFERENCE TO RELATED APPLICATIONS

This application claims the benefit of priority from U.S. Provisional Patent Application No. 61/866,766, filed Aug. 16, 2013. The disclosure of said patent application is expressly incorporated herein by reference in its entirety.

### FIELD OF THE DISCLOSURE

A method and apparatus to control a single-phase induction motor are disclosed. More specifically, a motor drive implements a method in which the single-phase induction motor is controlled to optimize performance.

### BACKGROUND OF THE DISCLOSURE

A single-phase induction motor may be provided with a start or auxiliary winding powered out-of-phase relative to a main winding. The phase difference enables the motor to start. Often, the start winding is disabled after a predetermined starting period. A start capacitor may also be used to generate a phase-delay between primary and secondary windings to generate a necessary higher starting torque. Additionally a run capacitor is often integrated in the circuit to increase the motor efficiency at nominal running condition.

Because of its very low cost and simplicity, a “conducting angle” method to adjust the speed the single-phase induction motor is very popular. The root-mean square (RMS) voltage applied in the motor is a function of a conduction angle that controls the switching time of a power switch in series with a winding of the motor. The conduction angle changes the amplitude of voltage applied in the motor but not the frequency. High harmonic content in the motor, low efficiency, and noise may result. Low power factor and limited speed range of operation are additional constraints of such method. Additionally, if used, start and run capacitors may remain in the circuit.

Among other disadvantages, capacitors degrade over time and must be replaced. Further, the capacity and performance, such as efficiency, of a mechanical machine driven by the motor may be determined by the motor windings' configuration and the capacitor, so that changing the capacity or improving the performance of the machine may require using a different motor winding/capacitor combination. On the other hand, variable speed motor controls involve complexity and cost which may be undesirable. It is desirable for economic and environmental reasons to configure systems and operating methods to operate single-phase induction motors over their operating range to optimize performance.

### SUMMARY OF THE DISCLOSURE

A motor drive and a method of controlling a motor are disclosed herein. Also disclosed is a method to operate a mechanical machine including a single-phase induction motor. In one embodiment, the method comprises selecting a run speed; and supplying to the motor with a motor drive a main winding voltage and an auxiliary winding voltage with a phase angle between them based on an optimal operation data set. The optimal operation data set corresponds to the selected run speed. The motor drive has a plurality of optimal operation data sets corresponding to a plurality of speeds, each optimal operation data set configured to simulate performance of the mechanical machine with a run capacitor selected to cause the mechanical machine to achieve optimal operation. Each optimal operation data set includes a main winding voltage value, an auxiliary winding voltage value, and a phase angle value. The mechanical machine may be a compressor, and the optimal operation may be the largest ratio of cooling capacity to watts input.

In one variation, the method further comprises: selecting a second run speed; and supplying to the motor a main winding voltage and an auxiliary winding voltage with a phase angle between them based on a second optimal operation data set corresponding to the second selected run speed to drive the motor at the second selected run speed.

The plurality of optimal operation data sets may be configured by operating the mechanical machine at each of the plurality of speeds, and for each of the plurality of speeds, driving the motor with the motor drive and with different capacitors coupled to the motor at different times to identify an optimal capacitor of the different capacitors that generates the optimal operation, and storing in the motor drive an optimal operation data set based on operation of the motor with the optimal capacitor.

In one embodiment, the motor drive comprises control logic; and a power stage adapted to supply a main winding voltage and an auxiliary winding voltage to a single-phase induction motor of a mechanical machine. The control logic includes a plurality of optimal operation data sets corresponding to a plurality of speeds, each optimal operation data set configured to simulate performance of the mechanical machine with an optimal capacitor selected to cause the mechanical machine to achieve optimal operation, each optimal operation data set including a main winding voltage value, an auxiliary winding voltage value, and a phase angle value. The mechanical machine may be a compressor.

In some embodiments, a motor drive comprises an input interface configured to receive a soft-capacity selection; a power stage including a plurality of power switches; and control logic coupled to the power stage and operable to control the power switches to output a first voltage and a second voltage to drive a single-phase induction motor at a constant speed corresponding to the soft-capacity selection.

### BRIEF DESCRIPTION OF THE DRAWINGS

The above-mentioned and other disclosed features, and the manner of attaining them, will become more apparent and will be better understood by reference to the following description of disclosed embodiments taken in conjunction with the accompanying drawings, wherein:

FIG. 1 is a block diagram of a known single-phase induction motor control circuit;

FIGS. 2 and 2A are schematic/block diagrams of embodiments of a motor drive including control logic set forth in the disclosure;

FIG. 2B is a block diagram of control logic described with reference to FIGS. 2 and 2A;

FIG. 3 is a schematic diagram of a single-phase motor drive according with another embodiment set forth in the disclosure;

FIG. 4 is a flowchart of an embodiment of a speed method control set forth in the disclosure;

FIG. 5 is a block diagram of an embodiment of motor drive operable to implement the method described with reference to FIG. 4; and

FIG. 6 is a flowchart of an embodiment of a method to optimize performance set forth in the disclosure.

Corresponding reference characters indicate corresponding parts throughout the several views. Although the drawings represent embodiments of various features and components according to the present invention, the drawings are not necessarily to scale and certain features may be exaggerated in order to better illustrate and explain the present invention. The exemplification set out herein illustrates embodiments of the invention, and such exemplifications are not to be construed as limiting the scope of the invention in any manner.

### DETAILED DESCRIPTION OF EMBODIMENTS OF THE DISCLOSURE

For the purposes of promoting an understanding of the principles of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrated devices and described methods and further applications of the principles of the invention which would normally occur to one skilled in the art to which the invention relates.

A method and apparatus to control a single-phase induction motor to increase performance are disclosed. More specifically, a motor drive implements a method to dynamically control the amplitudes and phase angle of motor voltages. Advantageously, dynamic phase angle control as disclosed herein may be used to optimize performance of a mechanical machine driven by the motor at different motor speeds, thereby optimizing performance over the operating range of the motor. The mechanical machine may be a compressor and the optimal performance may be the efficiency of the compressor, e.g. cooling capacity/input watts. The motor is operated without capacitors to avoid the disadvantages described above. Instead, the voltages and phase angle that result from operating the mechanical machine with a capacitor that yields optimal operation at each speed are generated with control logic and supplied to the motor. The capacitor that yields optimal operation at one speed, i.e. the optimal capacitor, may be different at each speed. Thus, there may be optimal capacitors for each speed, thus optimal performance data sets for each speed, each data set including at least main and auxiliary winding voltages and phase angle.

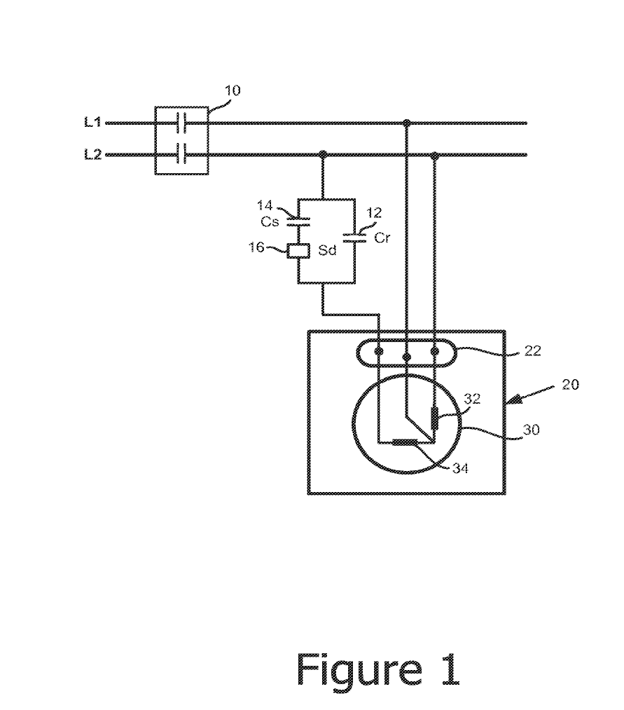

FIG. 1 is a schematic/block diagram of a single-phase compressor 20 having a motor 30 connected to a known start/run electromechanical device 10, which is coupled to lines L1 and L2 of a power supply. Compressor 20 may be a refrigerant compressor, such as a reciprocal piston compressor, a scroll compressor, a rotary compressor, or a screw compressor, for example, and may comprise part of a refrigeration system.

Exemplary electromechanical devices include contactors and relays. When engaged, electromechanical device 10 supplies power to drive motor 30 and single-phase compressor 20. An exemplary motor 30 includes an asynchronous single-phase induction motor. Motor 30 includes a main winding 32 and an auxiliary winding 34. A hermetic terminal 22 is interposed between the power lines and motor 30. In one example, a known control circuit (not shown) is operable to commutate a run capacitor Cr 12 and a start capacitor Cs 14. A start switch circuit Sd 16 is configured to drop off start capacitor Cs 14 after a given start time period. Start capacitor Cs 14 is typically used during start-up in high torque applications and may be disabled after start-up to increase efficiency by running with only the run capacitor. The capacity of compressor 20 is determined, at least in part, by the sizes and configurations of the capacitors and the motor.

Although FIG. 1 is described in the context of driving a compressor with a single-phase induction motor, the embodiments disclosed below are generally applicable to any mechanical machine including a single-phase induction motor, and the utility of the invention described herein is not limited to compressors. Compressor 20 and motor 30 may be referred to as, and are one example of, a mechanical machine.

In traditional systems, capacitors are sized to maximize performance and operation of a motor at a given power level. Motors that operate without capacitors have capacities defined by their windings' configurations. In both cases, with and without capacitors, the capacity to drive a load with a motor is determined by the power supplied to the motor. If the power supply components, such as the capacitors, are static, the capacity of a system to drive the load, and the efficiency thereof, may be limited, or defined, by the static components. Thus, motors and motor controls are sized based on the expected demand. Demand changes in excess of the design parameters can result in very inefficient operation, insufficient capacity, or both.

Motor drives, also called variable frequency drives (VFD), variable speed drives (VSD), and adjustable frequency drives (AFD), are designed to allow full torque and speed control of the motor. Generally, motor drives for medium voltage industrial applications comprise a converter section, a DC link, and an inverter section. The converter section converts line AC voltage to DC voltage. The DC link transmits the DC voltage to the inverter, provides ride-through capability by storing energy, and provides some insolation from the line AC voltage. The inverter converts the DC voltage to variable frequency AC voltage and transmits a variable voltage or current and frequency to the motor. By independently changing the voltage/current and frequency, the motor drive can adjust the torque produced by the motor as well as the speed at which it operates, respectively.

In one embodiment of a method for controlling a compressor, a motor is controlled with a motor drive to match operating values to stored values representative of optimal operating conditions to simulate the performance of start and run capacitors. Before operation, the compressor is tested with a calorimeter at several speeds of operation with start capacitor that allow startability and run capacitors that give the best compressor performance at each speed, referred to as “optimal capacitors”. The main and auxiliary voltages for each speed, and the shift phase between them, are stored in a Startability Table and a Run Table. The calorimeter measures the refrigeration capacity of the compressor by means of heat balance based on mass flow rate and specific enthalpy change. The tables thus comprise operating values which, when replicated, result in reliable starts and the best or optimal compressor performance at each speed, based on the optimal performance obtained with actual capacitors.

Initially, the input voltage of the compressor is verified. If the voltage is outside a safe range, a fault is indicated and known fault recovery procedures are implemented. If the voltage is within the safe range, the compressor enters a starting mode. In the starting mode, for different starting speeds the main and auxiliary voltages, and the phase angles, are selected from the Startability Table. Using soft-start logic, the compressor ramps-up by changing the Volts/Frequency (V/F) rate and the phase angles to reach a desired speed of operation. During the ramp-up, the main and auxiliary currents are compared to currents stored in the Startability Table. If the currents are outside a safe range, a fault is indicated and known fault recovery procedures are implemented. If the currents are within the safe range, the compressor enters a running mode. The selected voltages and phase angles simulate operation of the start capacitor, which is not utilized. The voltages and phase angles are determined for each compressor model to account for changes in motors and mechanical differences.

In the running mode, the main and auxiliary voltages, and the phase angles, are selected from the Run Table to operate at a selected frequency determined by speed control logic. The currents are monitored to detect faults, and corrective action is taken if necessary as described above.

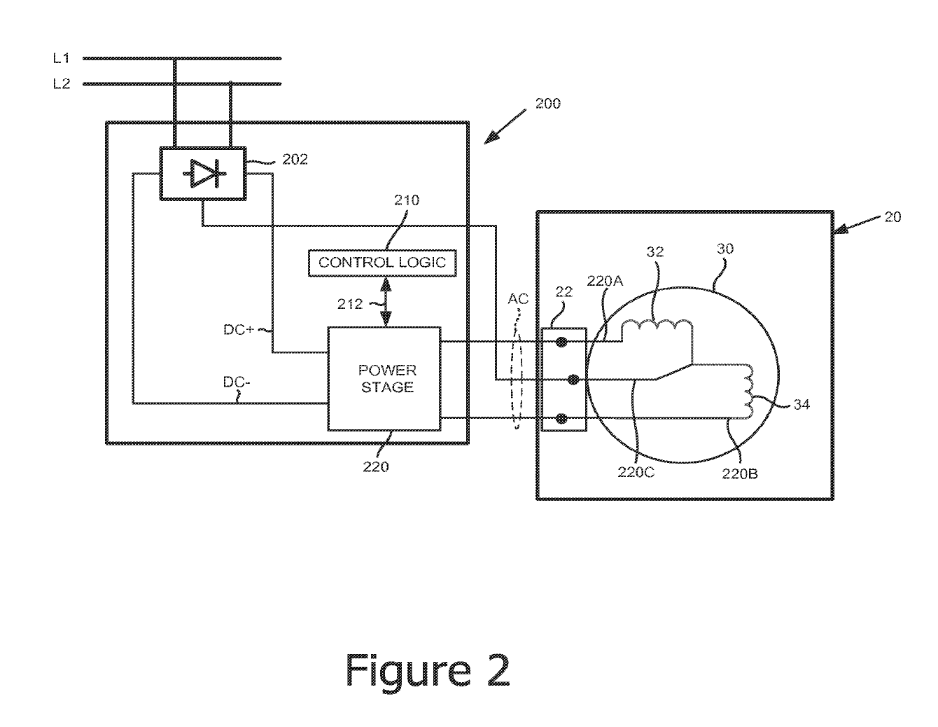

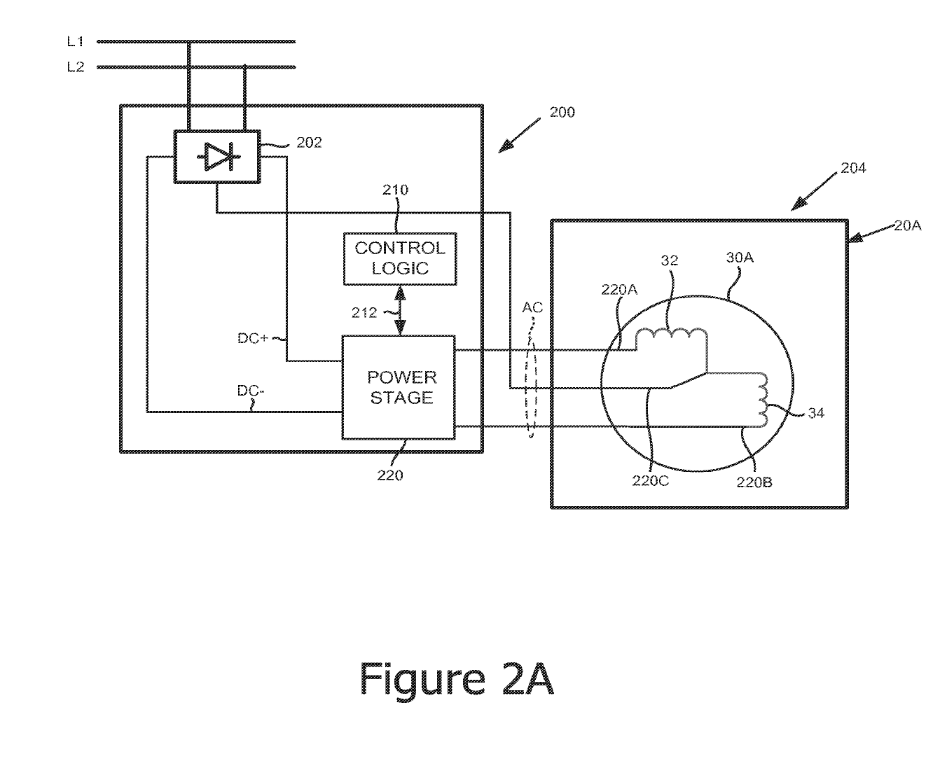

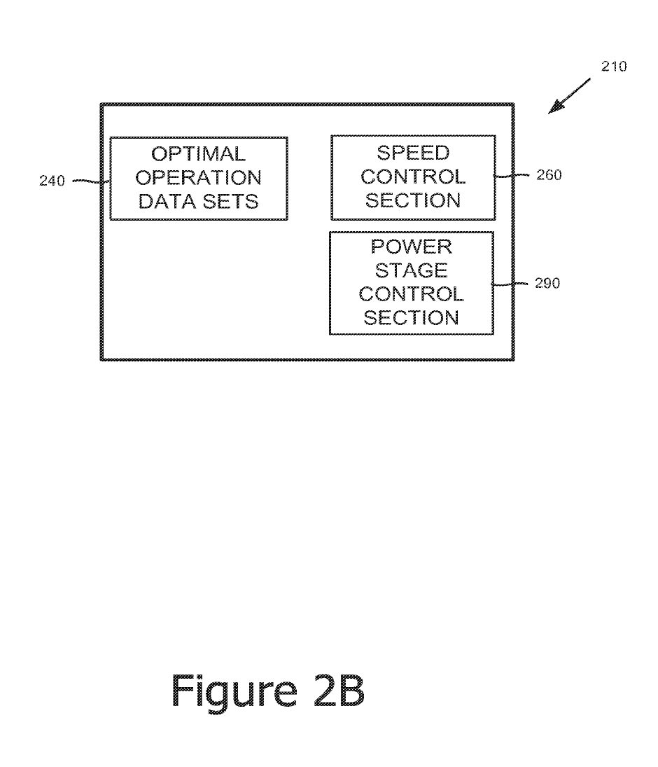

FIG. 2 is a schematic/block diagram of an embodiment of a single-phase induction motor drive, denoted by numeral 200. In the present embodiment, single-phase induction motor drive 200 is coupled to compressor 20 having motor 30. Power to control motor 30 is provided by lines L1 and L2 through a converter circuit 202, which converts alternating current (AC) power to direct current (DC) power. DC power is supplied to a power stage 220 of motor drive 200. Control logic 210 provides control signals 212 to power stage 220 to generate a desired AC power to drive motor 30. Control logic 210 and power stage 220 may be referred to, collectively, as the inverter. While the incoming AC power is generally provided at the fundamental line frequency, the frequency of the AC power generated by motor drive 200 to drive motor 30 is controllable. Lines 220A, 220B and 220C transfer the desired AC power from power stage 220 to motor 30. Although FIG. 2 is described in the context of operating a compressor, motor drive 200 may also drive other types of mechanical machines. FIG. 2A illustrates motor drive 200 coupled to an electromechanical system 204 comprising a generic mechanical machine denoted by numeral 20A including a motor 30A.

Control logic 210 may be referred to as capacitor simulation logic. The parameters of capacitor simulation logic may be determined empirically by characterizing operating parameters of a motor coupled to start and/or run capacitors, as described further below. In an exemplary embodiment shown in FIG. 2B, control logic 210 comprises a data-structure including a plurality of optimal operation data sets 240 corresponding to a plurality of speeds, each optimal operation data set including a main winding voltage value, an auxiliary winding voltage value, and a phase angle value. Phase angle values include values of parameters corresponding to phase angle, which may include degrees, time, time delay, and any other suitable indicator of a phase angle between two voltages and/or currents.

The optimal operation data sets may include current values obtained by measuring current when the mechanical machine has a nominal load. Current may be measured at the motor windings, the DC link, or the converter.

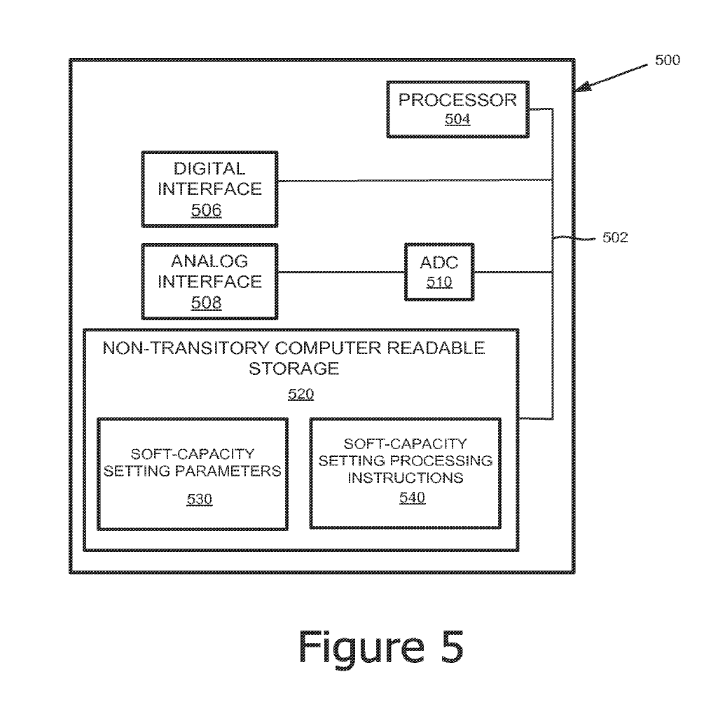

Control logic 210 further comprises a speed control section 260 and a power stage control section 290. As used herein, sections are portions of logic and may therefore comprise firmware, software, hardware and combinations thereof, without regard to where the sections are located on the drive. Typically, the sections may comprise subroutines or objects called by a main control portion of control logic 210. In one variation of the present embodiment, control logic 210 is embodied in a motor drive, such as the motor drive described with reference to FIG. 5, including a processor and is embedded in a non-transitory computer readable medium, or memory.

The plurality of speeds may include the minimum and maximum speeds and speeds therebetween. Speed values may be expressed in revolutions-per-minute of the motor, in Hertz (voltage frequency), or in other suitable representations of speed. While performance may improve if the plurality of speed values includes only the minimum and maximum speed values, additional speed values will refine operation of the motor drive and due to the low cost of memory will not significantly increase the cost of the motor drive. In one example, the plurality of speed values includes speeds between the minimum and maximum speed in 1 Hertz increments. In another example, the plurality of speed values includes speeds between the minimum and maximum speed in 5 Hertz increments. If the desired speed is between the included speed values, performance can be improved by selecting values, as described below, from the speeds that are closest to the desired speed. The minimum speed may be defined as the highest frequency at which the motor does not rotate. The minimum speed may also be defined as zero frequency. Other definitions of minimum speed are also suitable. Advantageously, the capacitor simulation logic enables optimal operation of the mechanical machine over its entire speed range. In one example, the speed range encompasses 30-120 Hertz. In another example, the speed range encompasses 40-100 Hertz.

Speed control section 260 is configured to set the speed of the motor. In systems with user interfaces in which the user selects a setpoint speed, speed control section 260 receives the input from the user interface and calculates one or more speeds to bring the motor from its current operating speed to the desired speed. Speed control section 260 may include known proportional-integral-derivative control logic operable to ramp the speed up or down without causing current faults or undesirable torque ripples and to change the speed at predetermined acceleration/deceleration rates. Speed control section 260 may comprise a known soft start logic portion for starting motor rotation. In compressors with predefined speeds, speed control section 260 may select one of the predefined speeds based on parameters resulting from operation of the compressor such as coolant or ambient temperature, and pressures. Other known logic for setting a motor speed may also be utilized based on the system in which the motor is used.

Power stage control section 290 receives a speed signal from the speed control section and generates control signals 212 for power stage 220. Depending on the topology of power stage 220, control signals 212 may indicate to power stage 220 the desired voltages and phase angle of the motor voltages, and power stage 220 may then calculate the appropriate PWM signals to generate the desired voltage. In another example, power stage 220 comprises a plurality of IGBTs, and power stage control section 290 includes the PWM algorithm needed to provide the appropriate switching timing to the IGBTs via control signals 212. In one variation, power stage control section 290 selects an optimal operation data set from optimal operation data sets 240 based on the speed signal, and generates signals to provide the motor main and auxiliary winding voltages corresponding to the main and auxiliary winding voltage values in the optimal operation data set, shifted by phase angle in the optimal operation data set.

Control logic 210 may be implemented in any motor drive, including variable frequency drives, which typically include a processing device and application logic corresponding to an application such as an HVAC or pumping application. Variable frequency drives are classified in six major topologies: Voltage-Source Inverter (VSI) Drives, Current-Source Inverter (CSI) Drives, Six-Step Inverter Drives, Load Commuted Inverter (LCI) Drives, Cycloconverters and Doubly Fed Slip Recovery Systems. Several types of designs are avaiable with these topologies as follows. The VSI drives are most widely used in low and medium power applications but are not used widely in high power applications. The embodiments of control logic disclosed herein are applicable in these topologies to more efficiently drive induction motors.

The single-phase ac/ac chopper uses only four power switches, such as insulated gate bipolar transistors (IGBTs), to minimize harmonic injection and is used to control induction motors with run capacitors (PSC motors). Pulse-width-modulation (PWM) strategies are implemented to control the motor. However, the speed variation will be over a limited range.

The single-phase ac/ac cycloconverter is an extension ac/ac chopper and it uses 12 more diodes. Current and torque can be managed properly but the efficiency is affected at low motor speed. The motor cannot operate above the nominal speed. The run capacitor remains in the circuit.

The single-phase full-bridge PWM inverter needs a DC filter capacitor, a full bridge diode rectifier and a full bridge IGBT. The run capacitor remain in the circuit.

The half-bridge rectifier full-bridge PWM inverter is similar to single-phase full-bridge PWM but with two less diodes and no need of DC filter capacitor. The run capacitor remains in the circuit. With this design it is possible to obtain lower vibration and lower motor noise than with other topologies.

The controlled rectifier with full bridge PWM inverter is an extension of half-bridge rectifier full-bridge PWM inverter and can limit the total harmonic distortion. This drive system has a wide speed range in the forward and backward directions with regenerative capability. The run capacitor remains in the circuit.

The half bridge rectifier with half bridge PWM inverter needs a DC bus filter capacitor and only two IGBTs and two diodes are used. The run capacitor remains in the circuit and the main constraint is the difficulty in having the dc bus mid-point balanced.

The controlled half-bridge rectifier with half-bridge inverter is an extension of previous half bridge rectifier and has the same problem that is the difficulty in having the dc bus mid-point balanced. The run capacitor also remains in the circuit.

The two-phase full bridge PWM inverter has an H-bridge to supply each winding. The two windings voltages and currents can be controlled independent of each other. Therefore, accurate control of torque and speed is possible. In this design eight power switches are used. A run capacitor in not needed in the circuit. The main and auxiliary windings are supplied separately.

The two-phase half-bridge PWM inverter is a half bridge version of the previous drive. In this case only four switches are used. The primary constraint is that the motor will operate under half of the rated voltage and the critical point is having the dc bus mid-point balanced. A run capacitor in not needed in the circuit.

The two-phase semi-full bridge PWM inverter (Six Step Inverter Drive) uses a six pack IGBT module to control the induction motor. There is no need of DC bus filter capacitor and run capacitor. The constraint is that motor will operate under half of the rated voltage. This type of converter is conventional in CSI drives.

The two-phase PWM inverter with controlled rectifier can have the source current, supply power factor and harmonic content controlled by using IGBTs instead of diodes. It is possible having the full rated voltage applied in the motor windings with some special implementation. There is no need of run capacitor.

The two-phase semi-full bridge PWM inverter uses six pack IGBT module to control the induction motor. There is no need of DC bus filter capacitor and run capacitor. The constraint is that motor will operate under half of the rated voltage. The main constraint is the difficulty in having the dc bus mid-point balanced.

The various speed control techniques implemented by modern variable frequency drives are mainly classified in the following three categories: Scalar Control (V/f), Vector Control and Direct Torque Control (DTC).

In the Scalar Control (V/f) the motor is fed a variable frequency signal generated by the PWM control from an inverter. The only information necessary are the voltage V and frequency f and the ratio V/f is maintained constant in order to get constant torque over the entire operating range. Generally, these drives are open loop control type, easy to be implemented and of low cost and thus widely used.

The Vector Control is also known as “Field Oriented Control”, “Flux Oriented Control” or “Indirect Torque Control” and is one of most used control methods of modern AC drive systems and has three different possibilities of control: stator flux oriented control, rotor flux oriented control and magnetizing flux oriented control. The limiting feature of these methods is how the flux is measured or estimated. Flux sensing coils (direct vector control) or measurement of speed, stator current and voltage, and the motor's equivalent circuit model (indirect vector control) are necessary.

The Direct Torque Control is the latest AC motor control method, developed with the goal of combining the implementation of the V/f based induction motor drives with the performance of those based on vector control. It uses an adaptive motor model that is based on mathematical expressions of basic motor theory. The model requires information about the various motor parameters like stator resistance, mutual inductance, saturation coefficients, efficiency and so forth. This method is capable of controlling the stator flux and torque more accurately than the vector controlled drives. Field orientation is possible to be achieved without rotor speed or position feedback using advanced motor theory to calculate the motor torque directly without using modulation. Additionally, controller complexity is greatly reduced.

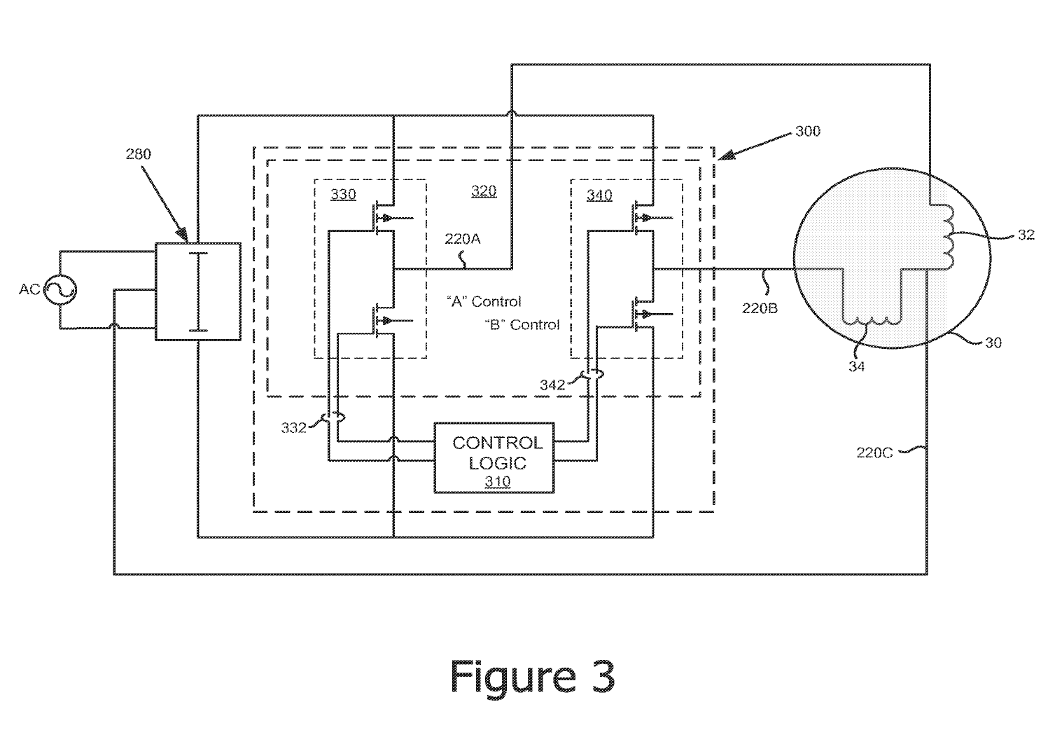

FIG. 3 is a schematic diagram of another embodiment of a single-phase motor drive, denoted by numeral 300. As shown, single-phase motor drive 300 includes control logic 310 and a power stage 320. Control logic 310 is coupled to first power switches 330 (“A” control) and second power switches 340 (“B” control) of power stage 320 by control lines 332 and 342, respectively. Control logic 310 is operable to power main winding 32 and auxiliary winding 34 by controlling first power switches 330 and second power switches 340. Control logic 310 is configured to switch first power switches 330 to generate a first predetermined amount of power to be provided to main winding 32 of motor 30. Control logic 310 is also configured to switch second power switches 340 to generate a second predetermined amount of power to be provided to auxiliary winding 34 of motor 30. The first and second predetermined amounts may be determined based on a selected soft-capacity of single-phase motor drive 300. As used herein, soft-capacity refers to an artificially set capacity which may be the same or lower than the actual capacity of the compressor. Thus, the soft-capacity may be set to 100% or less than 100% of the capacity of the compressor. The soft-capacity may be selected when the compressor is assembled with the motor, for example. The soft-capacity may also be selected (or changed) before delivery of the compressor. Alternatively, the soft-capacity may be selected during installation by a technician.

In one variation of the present embodiment, control logic 310 is embodied in a motor drive including a processor and processing instructions embedded in a non-transitory computer readable medium, or memory. An exemplary motor drive including processing instructions embedded in memory is described below with reference to FIG. 5. In the present variation, the processing instructions are configured to generate a main winding voltage and an auxiliary winding voltage having predetermined frequencies and voltages based on the selected soft-capacity.

In one example of the present variation, the memory includes sets of parameters indexed to different soft capacities. When a soft-capacity is selected, control logic 310 selects a corresponding set of load setting parameters which, when output by power stage 320, limit the speed of the motor to drive the compressor to achieve no more than the soft-capacity. Exemplary soft-capacity setting parameters include frequencies, voltages, phase-angles, duty-cycles and other power parameters configurable to control operation of single-phase motors. In one example, control logic 310 includes depress-in-place (DIP) switches, and the processor reads the DIP switches to identify the desired soft-capacity. In another example, control logic 310 includes a user interface operable by a user to select a soft-capacity. In a further example, a technician couples a mobile device to the drive to select a set of soft-capacity determining parameters from a plurality of sets of soft-capacity determining parameters. Once a set is selected, the remaining sets are permanently deleted.

In another variation of the present embodiment, the processor generates the power voltages based on the soft-capacity setting parameters and a voltage formula including the soft-capacity setting parameters. For example, the processor may calculate time-based amplitudes based on a frequency and maximum amplitude. In another variation of the present embodiment, the processor generates the power voltages by reading time-based amplitudes and other values from tables, the tables comprising the soft-capacity setting parameters. In both variations, the power voltages are generated by sending switching signals through lines 332 and/or 342 to first power switches 330 and second power switches 340, respectively.

In another variation of the present embodiment, control logic 210 is provided in addition to or in place of control logic 310, to optimize the performance of compressor 20. Thus, power stage control section 290 receives the phase angle control and speed control outputs indicative of the speed and phase angle control values computed by speed control section 260 and phase control section 280 and generates control signals 332 and 342 for power stage 320. The speed range may be limited by the selection of a desired soft-capacity with control logic 310.

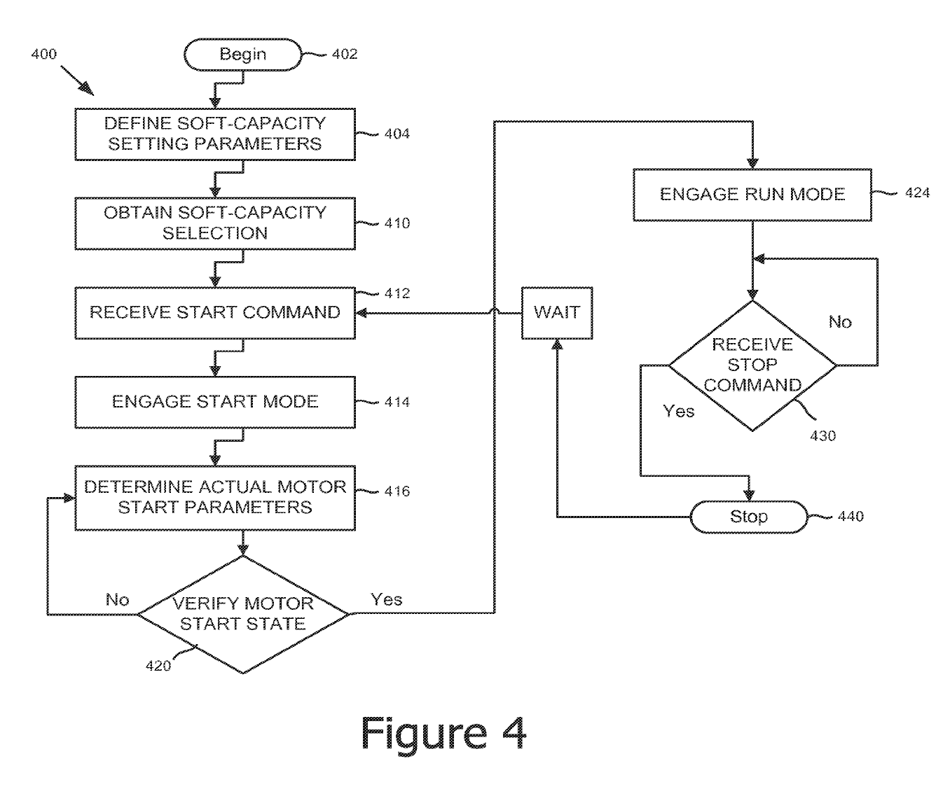

FIG. 4 is a flowchart of an embodiment of a method executable with control logic of a single-phase induction motor drive. The method begins at 402. At 404 the soft-capacity setting parameters are defined. As described above, the soft-capacity setting parameters set the potential parameters of a motor to drive a mechanical machine. At 410, the method continues with obtaining a soft-capacity selection. The soft-capacity selection may be received from the user upon outputting a prompt for the user. The soft-capacity selection may also be read from a DIP switch or other programmable circuit.

At 412, a start command is received. An exemplary start command may comprise a signal from a start push-button, a mobile device application, or any other output signal generating device.

At 414, a start mode of operation is engaged. The start mode of operation may be engaged by applying a start portion of the soft-capacity setting parameters (e.g. motor start parameters) to the power stage and outputting the corresponding power voltages to the motor.

At 416, actual motor start parameters are determined. The actual motor start parameters may be measured in analog or digital form from voltage and current transducers, for example. At 420, the motor start state is verified. The motor start state may be verified to ensure proper starting and determine that the motor's currents have stabilized at a given operating speed.

At 424, if the motor start state is verified, a run mode of operation is engaged. The run mode of operation may be engaged by applying a run portion of the soft-capacity setting parameters (e.g. motor run parameters) to the power stage. The start and run modes simulate motor operation with start and run capacitors.

At 430, receipt of a stop command is determined. Exemplary stop commands include signals from stop push-button, signals from safety circuit contacts, and demand signals indicating that demand has been satisfied and motor operation is no longer required. If a stop command is received, the method ends at 440. Otherwise, the method continues.

In one variation, a technician may change the selected soft-capacity. In another variation, the soft-capacity selection is a one-time event.

FIG. 5 is a block diagram of an embodiment of a motor drive 500 operable to implement the method described with reference to FIG. 4. Motor drive 500, and variations thereof, may implement the functions performed by control logic 210 and 310. As shown, motor drive 500 includes a processor 504, a digital interface 506, an analog interface 508, an analog to digital converter (ADC) 510, and non-transitory computer readable storage medium, or memory, 520. These components are communicatively coupled by a data bus 502 to transfer data therebetween. Memory 520 has embedded therein capacity setting parameters 530 and capacity setting processing instructions 540. Capacity setting parameters 530 and soft-capacity setting processing instructions 540 may be programmed before or after installation of the motor drive, including motor drive 500, with the motor and the load (e.g. a compressor assembly). Soft-capacity setting parameters 530 may also be uploaded before or after assembly. For example, soft-capacity setting parameters 530 may be uploaded wirelessly or through a wired connection, e.g. via the internet.

Digital interface 506 and analog interface 508 comprise known circuits configured to receive and/or output control signals, and may be configured depending on the overall system. One or both of digital interface 506 and analog interface 508 may include input sections configured to receive start and stop signals, capacity selections, and motor parameters. For example, digital interface 506 may be configured to include an input section to read digital signals corresponding to voltages or currents. Further, a DIP switch may be read by digital interface 506. One or both of digital interface 506 and analog interface 508 may include output sections configured to send control signals to the power stage and, optionally, operating parameters such as voltage, current, temperature, speed and any other parameter to a display or to a supervisory system.

Motor drive 500 may be implemented in any other form. In one example, motor drive 500 is implemented in a field-programmable-gate-array (FPGA).

In another embodiment, motor protection control logic is provided. Motor protection control logic may include known linear logic and also adaptive logic. Known linear logic includes under-voltage and over-current protection, for example. Adaptive logic includes fuzzy logic, particle swarm organization (PSO), and any other logic algorithm operable to adaptively determine an operating parameter limit and to take protective and/or remedial actions based on the determination. For example, adaptive logic may monitor coolant pressure and temperature during periods in which the load behaves normally, which may be indicated by the user, and then detect anomalies when operations deviate from the normal behavior. Adaptive logic is particularly well suited for application in which motors are mechanically coupled to compressors configured to operate in different types of environments, so that the adaptive logic can “learn” the type of load behavior which is normal and protect the motor and the compressor when the load does not behave normally. Adaptive logic may also be applied in the start mode to start the motor in accordance with the type of environment or overall system in which the motor and compressor operate. Of course, the adaptive logic also adapts to the selected load in combination with the type of system, such that the signals transmitted to the power stage would differ depending on both the selected load and the type of system to which the motor and compressor are coupled (e.g. refrigeration, air conditioning, etc.). Linear logic may also be used to protect the motor if the system type is known.

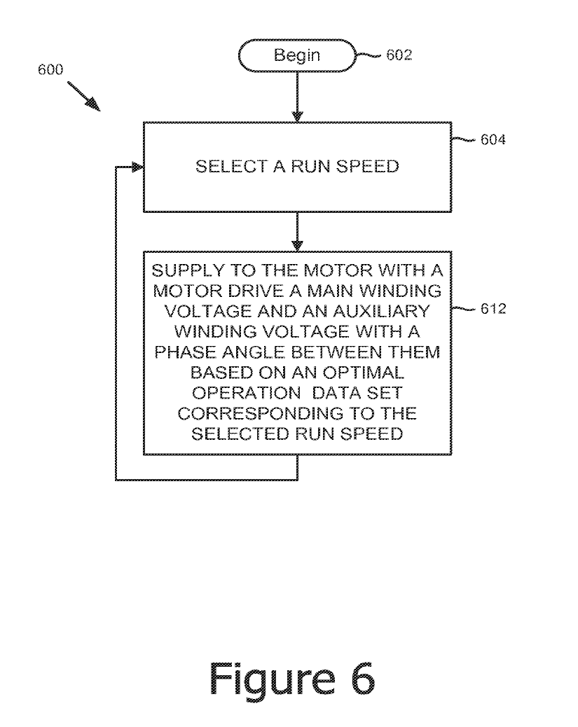

FIG. 6 is a flowchart of an embodiment of a method executable with control logic of a motor drive. The method begins at 602. At 604, the method comprises selecting a run speed.

At 612, the method further comprises supplying to the motor with a motor drive a main winding voltage and an auxiliary winding voltage with a phase angle between them based on an optimal operation data set corresponding to the selected run speed, the motor drive having a plurality of optimal operation data sets corresponding to a plurality of speeds, each optimal operation data set configured to simulate performance of the mechanical machine with an optimal capacitor selected to cause the mechanical machine to achieve optimal operation, each optimal operation data set including a main winding voltage value, an auxiliary winding voltage value, and a phase angle value. The plurality of optimal operation data sets may be configured by operating the mechanical machine at each of the plurality of speeds, and for each of the plurality of speeds, driving the motor with the motor drive and with different capacitors coupled to the motor at different times to identify the optimal capacitor from the different capacitors that generates the optimal operation, and storing in the motor drive an optimal operation data set based on operation of the motor with the optimal capacitor.

In one variation, the method further comprises selecting a second run speed; and supplying to the motor a main winding voltage and an auxiliary winding voltage with a phase angle between them based on a second optimal operation data set corresponding to the second selected run speed to drive the motor at the second selected run speed. The voltages and phase angle may be different for each speed, since the optimal capacitor may be different for each speed.

The mechanical machine may be a compressor, and the optimal operation may be the largest ratio of cooling capacity to watts input to the motor.

The plurality of speeds may have a range between 40 Hertz and 100 Hertz.

Each optimal operation data set may include a current value. The method may further comprise measuring a current; comparing the current to the current value; and changing the phase angle between the main winding voltage and the auxiliary winding voltage to reduce a difference between the current and the current value.

The method may further comprise receiving a selected soft-capacity; and limiting the speed of the motor based on the selected soft-capacity.

The term “logic” or “control logic” as used herein includes software and/or firmware executing on one or more programmable processors, application-specific integrated circuits, field-programmable gate arrays, digital signal processors, hardwired logic, or combinations thereof. Therefore, in accordance with the embodiments, various logic may be implemented in any appropriate fashion and would remain in accordance with the embodiments herein disclosed.

The terms “circuit” and “circuitry” refer generally to hardwired logic that may be implemented using various discrete components such as, but not limited to, diodes, bipolar junction transistors, field effect transistors, etc., which may be implemented on an integrated circuit using any of various technologies as appropriate, such as, but not limited to CMOS, NMOS, PMOS etc. A “logic cell” may contain various circuitry or circuits.

As used herein, an application, algorithm or, processing sequence, is a self-consistent sequence of instructions that can be followed to perform a particular task. Computer software, or software, executes an algorithm and can be divided into application software, or application, and systems software. An application executes instructions for an end-user, or user, where systems software consists of low-level programs that operate between an application and hardware. Systems software includes operating systems, compilers, and utilities for managing computer resources. While computing systems typically include systems software and applications software, they may also operate with software that encompasses both application and systems functionality. Applications may use data structures for both inputting information and performing the particular task. Data structures greatly facilitate data management. Data structures are not the information content of a memory, rather they represent specific electronic structural elements which impart a physical organization on the information stored in memory. More than mere abstraction, the data structures are specific electrical or magnetic structural elements in memory which simultaneously represent complex data accurately and provide increased efficiency in computer operation.

As used herein, a computing device may be a specifically constructed apparatus or may comprise general purpose computers selectively activated or reconfigured by software stored therein. The computing device, whether specifically constructed or general purpose, has at least one processor, or processing device, for executing machine instructions, which may be grouped in processing sequences, and access to memory for storing instructions and other information. Many combinations of processing circuitry and information storing equipment are known by those of ordinary skill in these arts. A processor may be a microprocessor, a digital signal processor (“DSP”), a central processing unit (“CPU”), or other circuit or equivalent capable of interpreting instructions or performing logical actions on information. Memory includes both volatile and non-volatile memory, including temporary and cache, in electronic, magnetic, optical, printed, or other format used to store information. Exemplary computing devices include workstations, personal computers, portable computers, portable wireless devices, mobile devices, and any device including a processor, memory and software. Computing systems encompass one or more computing devices and include computer networks and distributed computing devices.

As used herein, portable wireless devices include mobile phones, personal digital assistants, tablets, laptop computers, and any other portable devices with wireless connectivity.

As used herein, the transitional term “comprising”, which is synonymous with “including,” or “containing,” is inclusive or open-ended and does not exclude additional, unspecified elements or method steps. By contrast, the transitional term “consisting” is a closed term which does not permit addition of unspecified terms.

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A method of operating a mechanical machine including a single-phase induction motor, the method comprising:
selecting a run speed; and
supplying to the motor with a motor drive a main winding voltage and an auxiliary winding voltage with a phase angle between them based on an optimal operation data set corresponding to the selected run speed, the motor drive having a plurality of optimal operation data sets corresponding to a plurality of speeds, each optimal operation data set configured to simulate performance of the mechanical machine with an optimal capacitor selected to cause the mechanical machine to achieve optimal operation, each optimal operation data set including a main winding voltage value, an auxiliary winding voltage value, and a phase angle value.

2. A method as in claim 1, further comprising: selecting a second run speed; and supplying to the motor a main winding voltage and an auxiliary winding voltage with a phase angle between them based on a second optimal operation data set corresponding to the second selected run speed to drive the motor at the second selected run speed.

3. A method as in claim 1, wherein the plurality of optimal operation data sets are configured by operating the mechanical machine at each of the plurality of speeds, and for each of the plurality of speeds, driving the motor with the motor drive and with different capacitors coupled to the motor at different times to identify the optimal capacitor from the different capacitors that generates the optimal operation, and storing in the motor drive an optimal operation data set based on operation of the motor with the optimal capacitor.

4. A method as in claim 3, wherein the mechanical machine is a compressor, and the optimal operation is the largest ratio of cooling capacity to watts input.

5. A method as in claim 1, wherein the plurality of speeds have a range between 40 Hertz and 100 Hertz.

6. A method as in claim 1, each optimal operation data set including a current value, further comprising:
measuring a current;
comparing the current to the current value; and
changing the phase angle between the main winding voltage and the auxiliary winding voltage to reduce a difference between the current and the current value.

7. A method as in claim 1, further comprising:
soft-starting the motor with the motor drive by supplying to the motor main winding voltages and auxiliary winding voltages with phase angles between them based on a plurality of startability data sets, each startability data set configured to simulate performance of the mechanical machine with run capacitors and start capacitors selected to cause the mechanical machine to achieve optimal startability between zero Hertz and a selected minimum run speed.

8. A method as in claim 1, further comprising:
receiving a selected soft-capacity; and
limiting the speed of the motor based on the selected soft-capacity.

9. A method as in claim 1, wherein the motor is devoid of capacitors.

10. A method of making mechanical machine assemblies, the method comprising:
coupling a mechanical machine including a single-phase induction motor with a motor drive;
driving the mechanical machine with the motor drive at a plurality of speeds with a plurality of different capacitors connected to the motor at different times;
identifying for each speed an optimal capacitor from the plurality of different capacitors causing optimal operation of the mechanical machine; and
recording for each speed an optimal operation data set including a main winding voltage value, an auxiliary winding voltage value, and a phase angle value corresponding to the operation of the mechanical machine with the optimal capacitor; and
storing the plurality of optimal operation data sets in a plurality of motor drives configured to drive similarly sized mechanical machines.

11. A motor drive comprising:
control logic; and
a power stage adapted to supply a main winding voltage and a auxiliary winding voltage to a single-phase induction motor of a mechanical machine,
the control logic including a plurality of optimal operation data sets corresponding to a plurality of speeds, each optimal operation data set configured to simulate performance of the mechanical machine with an optimal capacitor selected to cause the mechanical machine to achieve optimal operation, each optimal operation data set including a main winding voltage value, an auxiliary winding voltage value, and a phase angle value.

12. A motor drive as in claim 11, wherein the plurality of optimal operation data sets are configured by operating the mechanical machine at each of the plurality of speeds, and for each of the plurality of speeds, driving the motor with the motor drive and with different capacitors coupled to the motor at different times to identify the optimal capacitor of the different capacitors as the capacitor that generates the optimal operation.

13. A motor drive as in claim 12, wherein the mechanical machine is a compressor, and the optimal operation is the largest ratio of cooling capacity to watts input.

14. A motor drive as in claim 13, wherein the plurality of speeds have a range between 40 Hertz and 100 Hertz.

15. A motor drive as in claim 11, each optimal operation data set including a current value, the control logic further configured to, for each speed, determine a current; and change the phase angle between the main winding voltage and the auxiliary winding voltage to reduce a difference between the current and the current value.

16. A motor drive as in claim 15, the control logic further configured to receive a selected soft-capacity and limit the speed of the motor based on the selected soft-capacity.

17. A motor driveethod as in claim 1, each optimal operation data set including a current value, further comprising:
measuring a current;
comparing the current to the current value; and
changing the phase angle between the main winding voltage and the auxiliary winding voltage to reduce a difference between the current and the current value.

18. A method as in claim 1, further comprising:
soft-starting the motor with the motor drive by supplying to the motor main winding voltages and auxiliary winding voltages with phase angles between them based on a plurality of startability data sets, each startability data set configured to simulate performance of the mechanical machine with run capacitors and start capacitors selected to cause the mechanical machine to achieve optimal startability between zero Hertz and a selected minimum run speed.

19. A method as in claim 1, further comprising:
receiving a selected soft-capacity; and
limiting the speed of the motor based on the selected soft-capacity.

20. A method of managing a production efficiency of compressor assemblies, the method comprising:
producing a plurality of identical compressor assemblies, each compressor assembly including a compressor, a single-phase induction motor to drive the compressor, and a motor drive, the plurality of identical compressor assemblies including a first group of compressor assemblies and a second group of compressor assemblies;
selecting a first compressor soft-capacity value in the motor drive of each of the first group of compressor assemblies, such that the first group will operate at the first compressor soft-capacity value; and
selecting a second compressor soft-capacity value in the motor control apparaturs of each of a second group of compressor assemblies, such that the second group will operate at the second capacity.

21. A motor control method comprising:
receiving a soft-capacity value; and
controlling a plurality of power switches to operate a single-phase induction motor at a constant speed corresponding to the soft-capacity value.

22. A motor drive comprising:
an input interface configured to receive a soft-capacity selection;
a power stage including a plurality of power switches; and
control logic coupled to the power stage and operable to control the power switches to output a first voltage and a second voltage to drive a single-phase induction motor at a constant speed corresponding to the soft-capacity selection.

23. A motor drive as in claim 22, the control logic including a set of soft-capacity setting parameters corresponding to the soft-capacity value selection, the set of capacity setting parameters including a first portion and a second portion, the first portion configured to control the single-phase induction motor during a start mode and the second portion configured to control the motor during a run mode.

24. A non-transitory computer readable medium having processing instructions embedded therein configured to implement a motor control method when executed by a processing device, the method comprising:
receiving a soft-capacity value parameter; and
controlling a plurality of power switches to drive a single-phase induction motor at a constant speed corresponding to the soft-capacity value.
